(19) United States
(12) Patent Application Publication
(10) Pub. No.: US 2010/0065144 A1
(43) Pub. Date: Mar. 18, 2010

(54) FIR anion fuel pipe for automobile and ship

(76) Inventor: Yixin Guo, Ronkonkoma, NY (US)

Correspondence Address: Yixin Guo, 256 Holbrook Ave., Ronkonkoma, NY, 11779, US

(21) Appl. No.: 12/283,895

(22) Filed: Sep. 17, 2008

(51) Int. Cl. F16L 9/14; F16L 9/00

(52) U.S. Cl. 138/146; 138/177

(57) ABSTRACT

A fuel pipe for vehicle and ship is described which is equipped by a FIR anion carrier structure with dual-function of both fuel transmitting and fuel saving. The device consists of a fuel pipe covered by a FIR and anion carrier structure which is made from tourmaline or tourmaline and germanium ore powder materials. The powder materials can be either nanoized or non-nanoized materials. The structures of the carrier can be granules set in or on the interior or exterior wall of the pipe, or paste carriers set on the interior or exterior of the pipe. The FIR anion carrier structures can facilitate sufficient combustion by breaking fuel molecular group into pieces, enhance the fuel-saving efficiency, and reduce the percentage of the toxic gas in the exhaust.

### FIELD OF THE INVENTION

This invention describes a fuel pipe with different embodiments that can be applied in vehicles and ships' gasoline or diesel engine. It is a distinct fuel pipe with FIR and anion carrier structure, especially when the carrier structure is a nano FIR and anion carrier. The fuel pipe can make fuel burn efficiently, and it can also reduce the emission of toxic exhaust such as carbon dioxide.

### BACKGROUND OF THE INVENTION

As the demand for petroleum soars, to fix the issues of both high cost of petroleum and the exhausted emissions from the devices consuming petroleum become challenges for the society. There are two different types of fuel economizers in the market, that is, economizers with either outer circle model or joint model. The principle of a fuel economizer is: when fuel is flowing to the fuel economizers, fuel economizer magnetizes fuel molecules. The fact that Carbon and Oxygen have opposite magnetic polarity induces that both Carbon and Oxygen are easily fused together producing a better and efficient combustion. As a result of the fusion of fuel and air, the engine works more efficiently generating greater power, reducing the consumption of fuel, and also the hydrocarbons (HC), carbon monoxide (CO) and nitrogen oxide which emanate from the exhaust.

The limitations of these two models of fuel economizers include: 1. Two models of fuel economizers can be installed only after customers bought the vehicles or ships, which is very inconvenient for both customers and manufacturers. 2. For the outer circle model and the joint model fuel economizers, there are technical problems with the installation. For example, for the joint model, in order to install the fuel economizer, the transmitting pipeline is needed to be severed. For this matter, it is very important to design a more effective fuel economizer to achieve the target of fuel saving.

### BRIEF SUMMARY OF THE INVENTION

The invention presents a FIR fuel pipe effective for fuel saving and beneficial for environmental protection. The embodiments of the invention are: a FIR anion fuel pipe for vehicles and ships. The said fuel pipe comprises a carrier structure. The said structure that is named as FIR and anion carrier structure are made up of tourmaline or tourmaline and germanium ore powder materials. The powder materials can be either nanoized or non-nanoized materials. Preferred embodiments of the present invention are described in more detail below with reference to the accompanying drawings. A plastic or rubber pipe with a carrier, where the structures of the carrier are described as follows:
1. A rubber or plastic fuel pipe for vehicle and ship, which has on it the FIR and anion carrier structures that are made up of tourmaline or tourmaline and germanium powder material.
2. A rubber or plastic fuel pipe as in claim 1, wherein the said carrier structures are made up of granules inlayed in the whole body of the said pipe. The granules can be either nanoized or non-nanoized materials.
3. A rubber or plastic fuel pipe, on which the structure of the carrier is granules made up of FIR and anion carriers inlayed in the interior or exterior of the wall of the pipe body. The granules can be either nanoized or non-nanoized materials.
4. A rubber or plastic fuel pipe, on which the structure of the carrier is paste made up of FIR and anion carriers pasted to the interior or the exterior of the wall of the pipe body. The paste are made up of either nanoized or non-nanoized materials.
5. A rubber or plastic fuel pipe as in claim 1, wherein inside diameter of said pipe is from 6 to 12 mm.
6. A rubber or plastic fuel pipe as in claim 1, wherein the said pipe consists of two layers-pipe body and carrier structures.

### DESCRIPTION OF THE DRAWINGS

FIG. 1 is a three-dimensional view of a fuel pipes for vehicles and ships;

FIG. 2 is a side view of embodiment 1: a fuel pipe for vehicles and ships. Structures of FIR and anion carriers are made up of nanoized or non-nanoized granules powder inlayed in the whole pipe body.

FIG. 3 is a side view of embodiment 3: fuel pipes for vehicles and ships with an interior layer of paste carrier; the paste carriers are made up of either nanoized or non-nanoized materials.

FIG. 4 is a side view of embodiment 4: a fuel pipe for vehicles and ships with an exterior layer of paste carrier; the paste carriers are made up of either nanoized or non-nanoized materials.

FIG. 5 is a side view of embodiment 5: a fuel pipe for vehicles and ships with interior layer carriers; the structures of carriers are made up of nanoized or non-nanoized granules powders inlayed in the interior wall of the pipe body.

FIG. 6 is a side view of embodiment 6: a fuel pipe for vehicles and ships with exterior layer carriers; the structures of carriers are made up of nanoized or non-nanoized granules powders inlayed in the exterior wall of the pipe body.

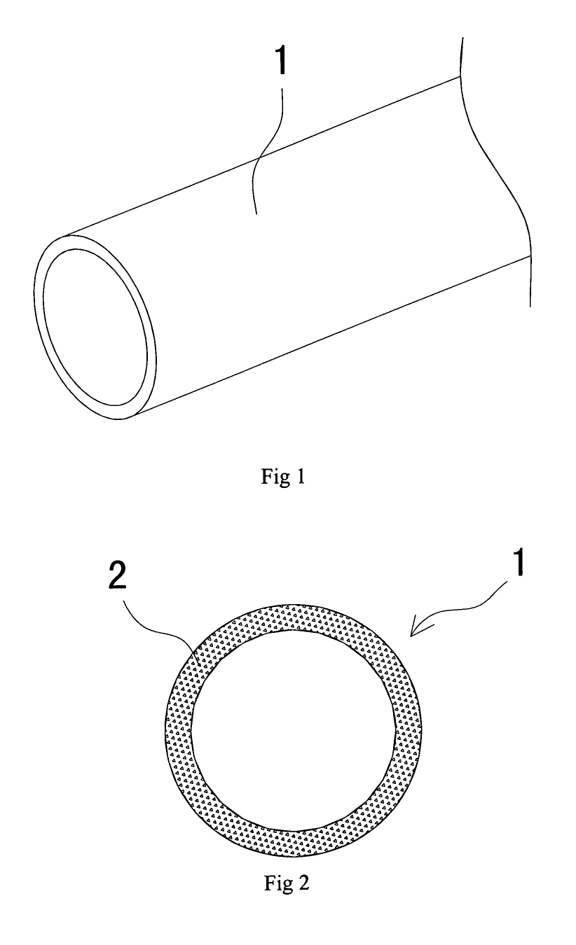

### DETAILED DESCRIPTION OF THE INVENTION

The terms and contents in the above technique are explained as follows:
1. In the above technique, the said “fuel pipe for vehicles and ships” means FIR fuel pipes in the internal combustion engines used in vehicles and ships that consume gasoline or diesel oil.
2. In the above technique, the said “tourmaline ore powder” can generate FIR and anion, and the said “germanium ore powder” mainly generates anions. Other materials that can generate anions include, but are not limited to: Gui gems, Shenzhou stones and Tourmaline. These anion materials can be used either separately or with two or more combined.
3. In the above technique, when FIR fuel pipes adopt the inlayed granule structures nano or non-nano granules with FIR and anions are mixed with general fuel pipe rubber or plastic materials. In the structures of carrier, 5-15% in weight is nanoized or non-nanoized granules materials and left 85˜95% in weight is either or plastic.
4. In the above technique, when fuel pipes adopt paste structures, granules with FIR and anions are mixed with general fuel pipe materials, that is, rubber and plastic in a form of paste. In the structures of carrier, 5-15% in weight is materials and left 85˜95% in weight is either rubber or plastic.
5. Tourmaline nano ore powder can generate high FIR and the emission rate up to 96%, which is higher than non-nano tourmaline ore powder's 85%; nano germanium ore powder can generate more anions than non-nano germanium ore powder.
6. Inside diameter of FIR and anion fuel pipe are from 6 mm to 12 mm.
7. Size of nano granules is in the order of nanometer, and preferred size is from 500 nm to 1000 nm.
8. Only two layers are included in the present invention, that is, carrier structures and pipe body itself.

The principle of the present invention is: when the fuel flows to FIR anion fuel pipe for vehicles and ships, the carrier structures of the said pipe emits FIR and anion. The emission directly acts upon the fuel. The van der Waals force between fuel molecules is destroyed by the effects of FIR and anion. Long-chain molecules become single molecules and/or short-chain molecules. Therefore the average distances between molecules increases and fuel molecules have more space free to move. As a result, burning efficiency of the fuel will be improved greatly and the exhausted toxic gases will drop correspondingly.

The present invention of FIR and anion fuel pipe for vehicles and ships have the following advantages over existing technologies with or without FIR and anion:
1. The present invention of FIR anion fuel pipe for vehicles and ships itself is a very good fuel economizer besides its fuel transportation.
2. The present invention of nano FIR anion fuel pipe for vehicles and ships has an emission rate increased to 96% from ˜85% by non-nanoized FIR and anion pipe. This emission rate is an unexpected result from non-nanoized FIR and anion pipe.
3. The present invention of FIR anion fuel pipe for vehicles and ships can save fuel up to 8%, also reduce the emission of toxic exhaust such as carbon dioxide up to 11%.
4. The present invention of nano FIR anion fuel pipe for vehicles and ships can save fuel up to 12%, also reduce the emission of toxic exhaust such as carbon dioxide up to 15%.

The present invention has been illustrated with samples.

Six embodiments of the present invention: a FIR anion fuel rubber or plastic pipe for vehicles and ships comprises a pipe body 1; there is FIR and anion granule carrier 2 in said pipe body 1; this granule carrier 2 comprises tourmaline or tourmaline and germanium ore powders. The powders can be either nanoized or non-nanoized materials. The carrier can be inlayed in the whole body, interior wall or exterior wall of the said pipe, as shown in FIGS. 2, 5 and 6, respectively, and the powders can be either nanoized or non-nanoized materials, so there are six embodiments in total.

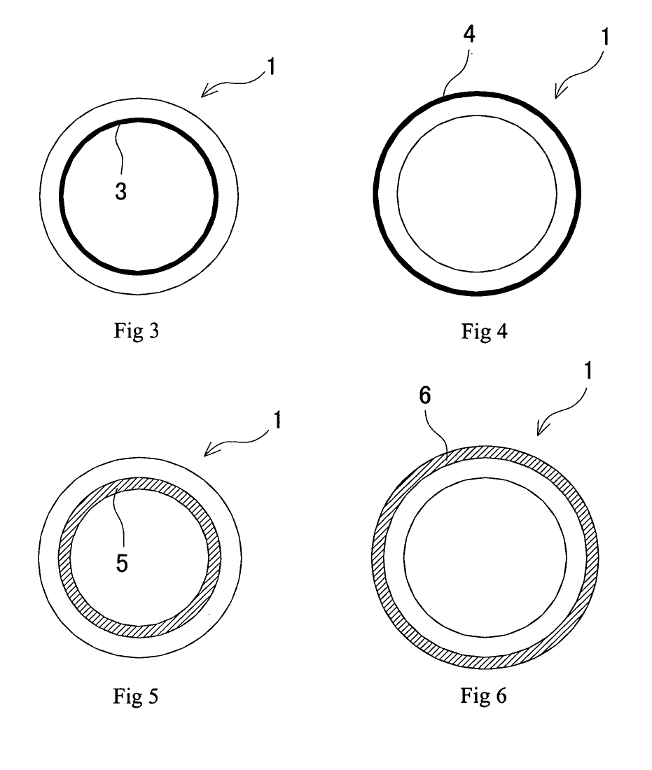

Another four embodiments of the present invention as illustrated in Item 3: a FIR anion fuel plastic or rubber pipe for vehicles and ships comprise a pipe body 1. On the interior wall of the pipe body 1, there is a layer of FIR and anion paste carrier 3, which consists of tourmaline or tourmaline and germanium ore powder. In the manufacturing process of fuel pipes, a layer of paste carrier could be pasted on the interior or exterior walls of said pipes as shown in FIG. 3 and FIG. 4, respectively. Similarly, the paste carrier structures can be made up of either nano or non-nano powder materials. There are another four embodiments in total.

In conclusion, there are ten different embodiments for the present invention.

1. A rubber or plastic fuel pipe, which has far infrared ray (FIR) and anion carrier structures that are made up of tourmaline powder materials, or made up of tourmaline and germanium powder materials.

2. A rubber or plastic fuel pipe as in claim 1, wherein the said carrier structures are made up of granules inlayed in the whole body of the said pipe.

3. A rubber or plastic fuel pipe as in claim 1, wherein the said carrier structures are made up of nano granules inlayed in the whole body of the said pipe.

4. A rubber or plastic fuel pipe as in claim 1, wherein the said carrier structures are made up of granules inlayed in the interior or exterior of the wall of the said pipe.

5. A rubber or plastic fuel pipe as in claim 1, wherein the said carrier structures are made up of nano granules inlayed in the interior or exterior of the wall of the said pipe.

6. A rubber or plastic fuel pipe as in claim 1, wherein the said carrier structures are paste pasted to the interior or the exterior of the wall of the said pipe. Said carrier structures can be made up of either nano or non-nano powder materials.

7. A rubber or plastic fuel pipe as in claim 1, wherein inside diameter of said pipe is from 6 to 12 mm.

8. A rubber or plastic fuel pipe as in claim 1, wherein the said pipe consists of two layers—pipe body and carrier structures.
